(19) United States
(12) Patent Application Publication
(10) Pub. No.: US 2026/0345431 A1
(43) Pub. Date: Nov. 5, 2026

(54) Massage Vest

(71) Applicant: Zhijian Li, Fuzhou (CN)

(72) Inventor: Zhijian Li, Fuzhou (CN)

(21) Appl. No.: 19/665,892

(22) Filed: May 1, 2026

Related U.S. Application Data
(60) Provisional application No. 63/798,556, filed on May 1, 2025.

(51) Int. Cl. A61H 23/00

(52) U.S. Cl. CPC A61H 23/00; A61H 2201/1621; A61H 2201/5007; A61H 2201/5071; A61H 2201/5082; A61H 2201/5084; A61H 2201/5097; A61H 2205/08

(57) ABSTRACT

A wearable vest includes massage heads and can include fasteners to connect to another wearable item. The vest can include a vest body, at least two massage vibrators, at least two fasteners configured for attaching to an associated wearable article, at least one adjustment strap, a power compartment for housing a power source, a controller, and at least two power lines connecting the at least two massage vibrators to the controller and the controller to the massage power source. The vest can include a temperature control layer, a temperature sensor, and one or more heating/cooling elements. The controller can be programmed to analyze data measured by the temperature sensor and control the one or more heating/cooling elements to control the temperature of the temperature control layer based on the data. The massage vest system can include a wireless communication module for communication with mobile devices.

### CROSS-REFERENCE TO RELATED APPLICATION

This application claims priority from and benefit of the filing date of U.S. provisional application Ser. No. 63/798,556 filed May 1, 2025, and the entire disclosure of said provisional application is hereby expressly incorporated herein by reference.

### FIELD

This disclosure is related to wearable items, and in particular to a wearable vest with massage heads to massage a portion of a body of a wearer of the vest, and to a wearable vest with fasteners to connect to another wearable vest or other items.

### BACKGROUND

Posture correction and body care is becoming more popular. Backpacks, vests, and other wearable items are known to include one or more battery operated massage heads for massaging the shoulders, neck, and/or back of a human wearer. There is a need for new and improved versions of such wearable vests to provide improved comfort, fit, effectiveness, and better overall results, in addition to providing fasteners for better positioning the vest around a wearer's body, along with other fasteners for attaching other items (such as bag, pillows, lights, etc.). The following discloses certain improvements to overcome these problems and others.

### SUMMARY

In some embodiments, a dynamically fitting and attachable massage vest system includes a vest body, at least two massage vibrators, at least two fasteners configured for releasably attaching to an associated wearable article, at least one adjustment strap for tightening the vest body to an associated user's body, a power compartment for housing a massage power source, a controller embedded in the vest body, and at least two power lines connecting the at least two massage vibrators to the controller and the controller to the massage power source.

In other embodiments, a massage vest system includes a massage vest body having at least one shoulder strap, a back panel, at least two massage vibrators, a power source, and a controller disposed thereon. The massage vest system can further include at least one releasable fastening assembly including a strap and a buckle system, wherein the strap is adapted to wrap around the at least one shoulder strap or a fixing strap of an associated article such that when the massage vest body is attached to the associated article via said at least one fastening assembly, the back panel of the massage vest and a contact surface of the associated article together conform to a user's torso.

One advantage of the present disclosure resides in providing a wearable vest that includes fasteners to improve the fit of the vest around a wearer's body.

Another advantage resides in providing a wearable vest that includes fasteners to allow other items to be attached to the vest.

Another advantage resides in providing a wearable vest that is able to heat or cool the wearer.

Another advantage resides in providing a wearable vest with massage heads that can be adjusted based on posture or activity state of a wearer of the vest.

A given embodiment may provide none, one, two, more, or all of the foregoing advantages, and/or may provide other advantages as will become apparent to one of ordinary skill in the art upon reading and understanding the present disclosure.

### BRIEF DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1 diagrammatically illustrates a wearable massage vest in accordance with an embodiment.

FIG. 2 diagrammatically illustrates a second massage vest that can be removable attached to the massage vest of FIG. 1.

FIG. 3 diagrammatically illustrates another embodiment of the wearable massage vest of FIG. 1.

FIGS. 4 and 4A diagrammatically illustrate another embodiment of the second wearable massage vest of FIG. 2.

FIGS. 5A and 5B diagrammatically illustrate another embodiment of the wearable massage vest of FIG. 1.

FIG. 6 shows a schematic of electronics embedded in the wearable massage vest of FIG. 1.

### DETAILED DESCRIPTION

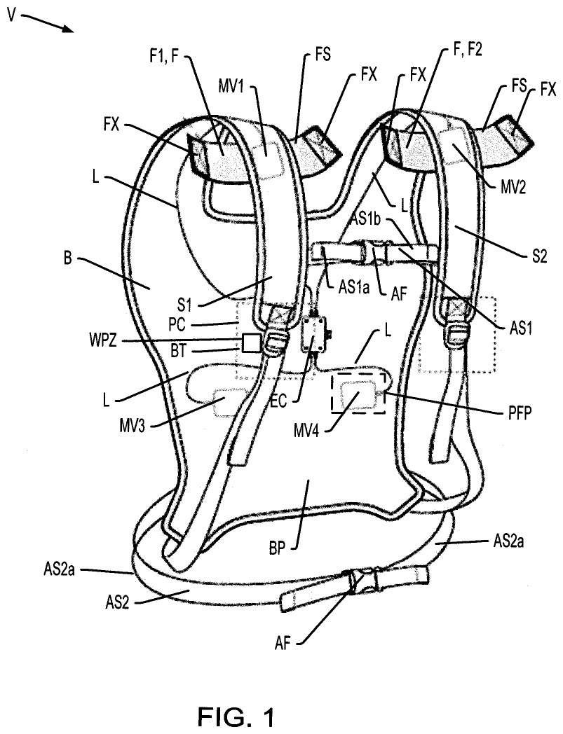

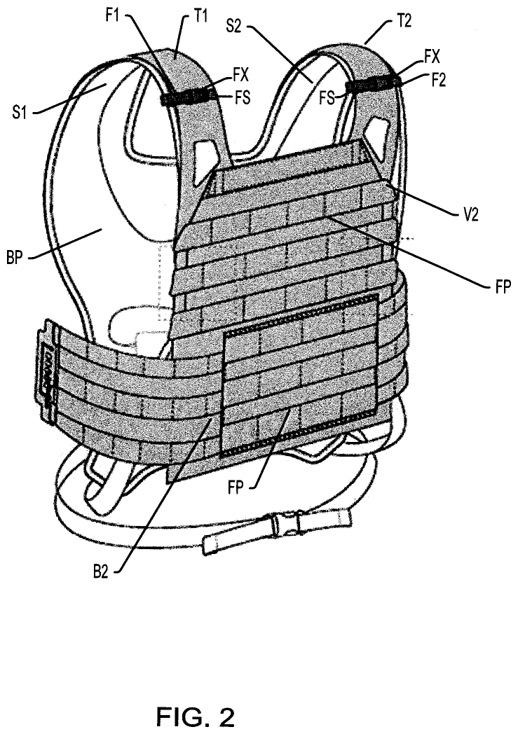

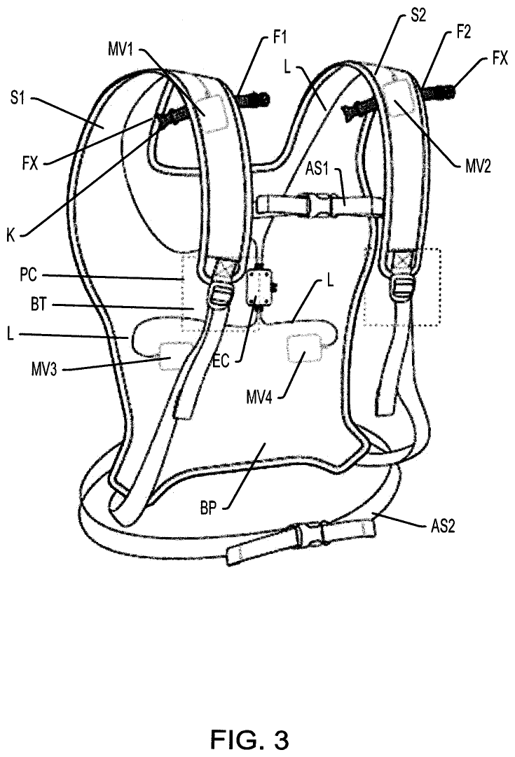

FIG. 1 shows a massage vest V that can be selectively attached to and detached from another wearable article such as a second vest V2 as shown in FIG. 2. The massage vest V can include a vest body B including at least two massage heads or massage vibrators connected to the vest body B for massaging and/or vibrating the body of a human wearer of the vest V alone, or a wearer of the combined vests V, V2 when the massage vest V is attached to the second vest V2 or another wearable article (not shown). As shown in FIG. 1, the vest body B comprises first and second massage vibrators MV1,MV2 connected respectively to first and second shoulder straps S1,S2 of the vest body B for respectively massaging and/or vibrating a human wearer's first and second (right and left) shoulders. The vest body B can also include third and fourth massage vibrators MV3,MV4 connected to a back panel BP of the massage vest body B for massaging or vibrating the human wearer's back. The second vest V2 can include a vest body B2 including first and second shoulder straps T1,T2 for resting on the human wearer's first and second (right and left) shoulders and a front panel FP for lying adjacent a chest of the human wearer.

The massage vest V can include at least two fasteners or fastening elements for selectively releasably securing the massage vest V to the second vest V2 or another wearable clothing article as shown in FIG. 2. As shown, the massage vest V includes first and second fasteners or fastening elements F1,F2 connected respectively to the first and second shoulder straps S1,S2. The fastening elements F1, F2 can each include a strap FS and a fastener system FX located on the opposite ends of the strap FS for selectively releasably connecting the opposite ends of the strap FS to each other. As shown in FIGS. 1 & 2, the fastener system FX comprises VELCRO or a similar hook-and-loop fastening system, but the fastener system FX can alternatively comprise a buckle, a snap, a clip, a magnet, adhesive, or any other releasable fastening system. As shown in FIG. 2, the fastening elements F1,F2 can be respectively wrapped around the shoulder straps T1,T2 of the second vest V2 or other wearable article and the fastener system FX of each fastening element F1,F2 can then be engaged to connect the opposite ends of the strap FS to each other to capture the fastening elements F1,F2 to the respective shoulder straps T1,T2 of the second vest V2 to thus releasably capture the massage vest V to the second vest V2. When the massage vest V is connected to the second vest V2, a back panel BP and the front panel FP of the vest body B are spaced apart and are positioned to lie adjacent a wearer's back and chest, respectively. The back panel BP and the shoulder straps S1, S2 are made from an elastic, breathable material.

The massage vest V can include at least one adjustment strap for tightening the vest to better fit the user's body for improved massage intensity. As shown herein, the massage vest includes an upper adjustment strap AS1 that extends between the first and second shoulder straps S1,S2. A first adjustment strap portion AS1a is connected to the first shoulder strap S1 and a second adjustment strap portion AS1b is connected to the second shoulder strap S2. The upper adjustment strap AS1 includes a clip or buckle or VELCRO (hook-and-loop), or other adjustment fastener AF for connecting the first and second strap portions AS1a, AS1b together and that allows the first and second strap portions AS1a, AS1b to be drawn together, or towards each other, to tighten the shoulder straps S1,S2 toward each other and to tighten the fit of the massage vest MV on the wearer.

The illustrated massage vest V also includes a lower adjustment strap AS2 that extends around the lower back or hips of the wearer. A first adjustment strap portion AS2a is connected to the back panel BP and a second adjustment strap portion AS2b is also connected to the back panel BP. The lower adjustment strap AS2 includes a clip or buckle or VELCRO (hook-and-loop), or other adjustment fastener AF for connecting the first and second strap portions AS2a, AS2b together and that allows the first and second strap portions AS2a, AS2b to be drawn together to tighten the lower adjustment strap AS2 around the back and hips of the wearer to tighten the fit of the massage vest MV on the wearer.

The back panel BP or other part of the massage vest MV includes a power compartment PC for housing a massage power source such as a rechargeable battery BT. The power compartment PC includes a waterproof zipper (or sealing cover) WPZ to protect the rechargeable battery BT from water exposure or damage.

The massage vest also includes a main board electronic processor or controller EC connected to the back panel BP or other part of the body B, and includes at least two power lines L (i.e., one power line L for each massage vibrator MV1, MV2, MV3, and/or MV4) respectively connecting each massage vibrator to the main board electronic controller EC and to the battery BT or other power source.

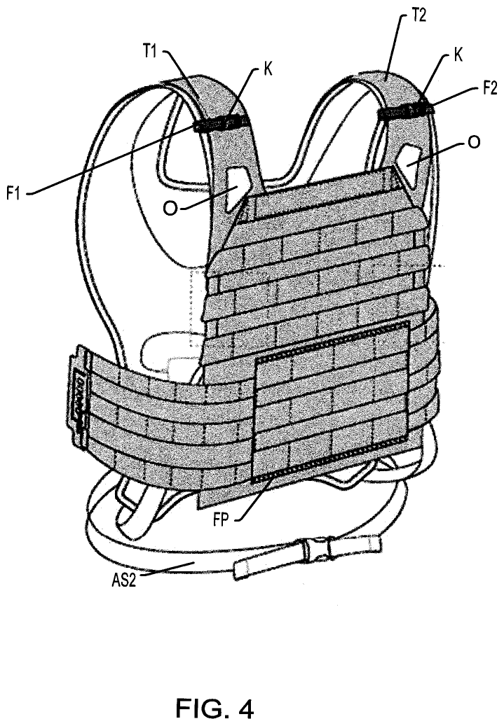

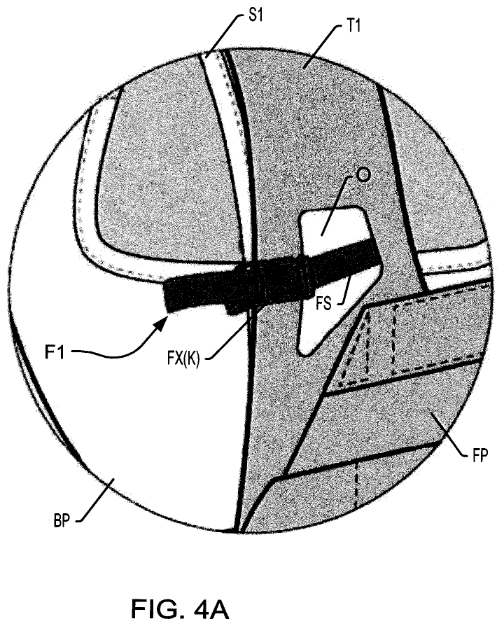

FIGS. 3 and 4 are respectively similar to FIGS. 1 and 2, but show that the fastener system FX can comprises a clip or buckle K. FIG. 4A shows that the second vest V2 (or other second wearable body V2) can comprise an opening or slot O through which the fastener strap FS can extend to secure the massage vest V to the second vest V2 or other wearable body V2.

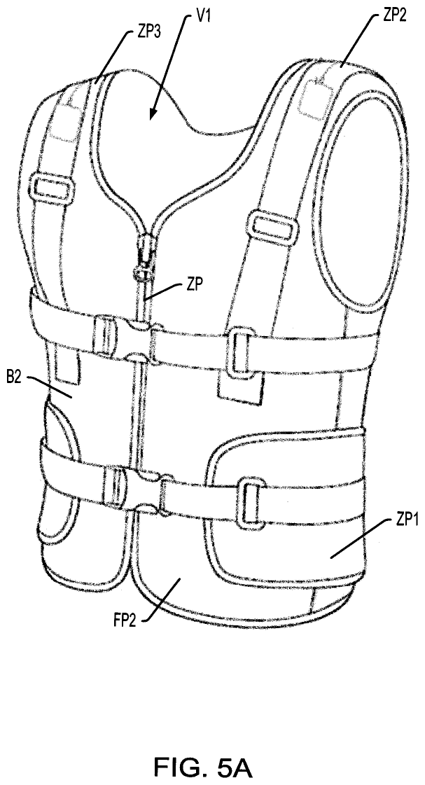

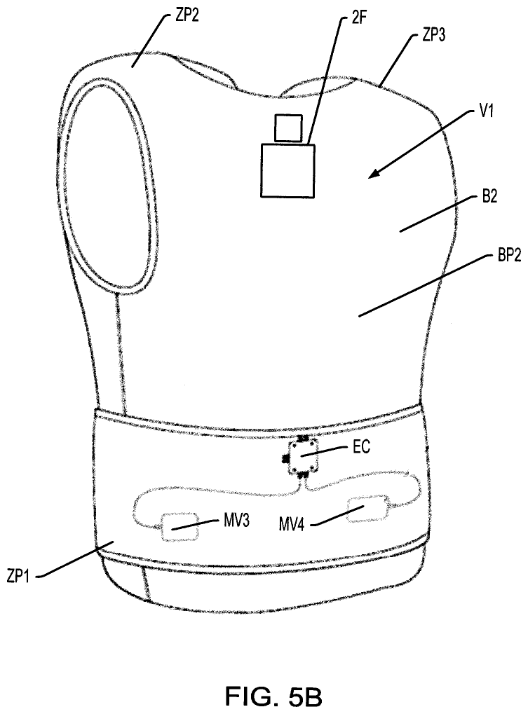

FIGS. 5A and 5B show an alternative massage vest V′ comprising a wearable vest body B2 that includes both the back panel BP2 and front panel FP2 and also includes the first and second shoulder straps S1,S2 that extend between and connect the back panel BP2 and front panel FP2. The front panel FP2 can include a zipper ZP or other reclosable front for opening and reclosing the front panel FP2 as required for a user to install the massage vest V′ on his or her body and for removing the massage V′ from his or her body. As shown herein, the massage vest V′ can include independent zonal support pieces ZP1,ZP2,ZP3 that are each dynamically adjustable structures to achieve better fitting with the human body for improved massage effects. Each zonal support piece ZP1,ZP2,ZP3 can include a corresponding respective strap for selectively tightening the zonal support piece ZP1,ZP2,ZP3 about the body of the wearer for improved massage effect from the massage vibrators MV1-MV4. As such, the zonal support pieces adaptively adjust according to ergonomic requirements of shoulders, waist, and back.

The massage vest V or V′ can include additional vest components such as force-bearing bags or neck support pillows that can be attached to the massage vest body B, B2 through second fasteners 2F to achieve better body-fitting effects.

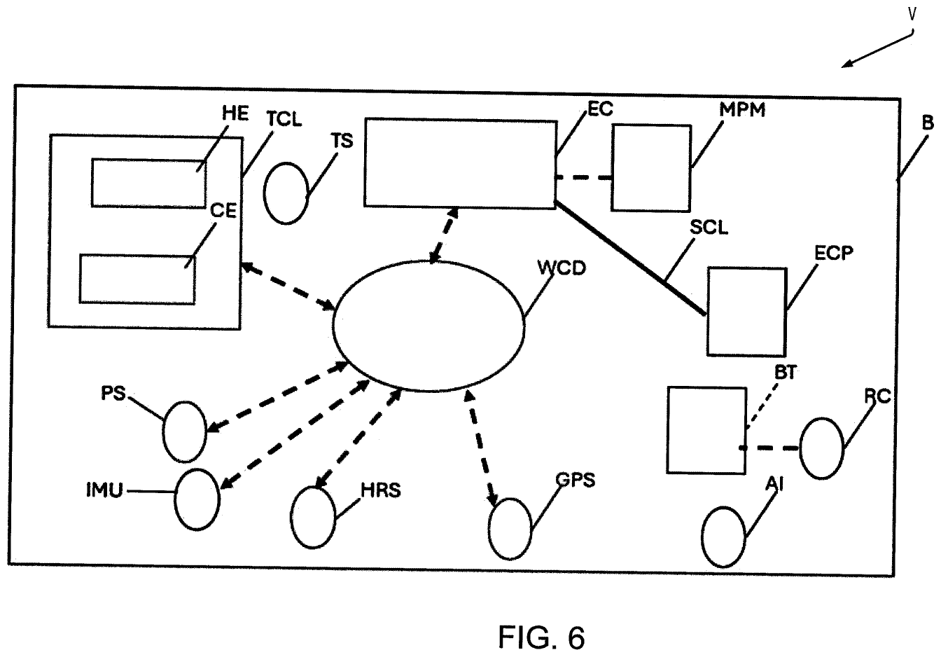

FIG. 6 shows a schematic view of electronics of the massage vest V (or the massage vest V′) configured to measure data that is then processed byte he electronic controller EC to adjust operation of the massage vest V. As shown in FIG. 6, the massage vest V can include a temperature control layer TCL integrated into the vest body B, a temperature sensor TS, and one or more integrated heating elements HE and/or one or more cooling elements HE. The temperature sensor TS can be disposed on a portion of the vest body B, or on one of the heating/cooling elements HCE. The temperature sensor TS is configured to measure data, such as the body temperature of the human wearer of the massage vest V. The electronic controller EC is programmed to receive the measured temperature data from the temperature sensor TS, and control the heating elements HE and/or the cooling elements CE to operate to heat or cool the temperature control layer TCL to correspondingly heat or cool the human wearer. For example, if the measured temperature data indicates that the human wearer is hot, the electronic controller EC can activate the cooling elements CE to lower the temperature of the TCL, which thereby will lower the temperature of the human wearer. Conversely, if the measured temperature data indicates that the human wearer is cold, the electronic controller EC can activate the heating elements HE to increase the temperature of the TCL, which thereby will increase the temperature of the human wearer.

As shown in FIG. 6, the massage vest V can a pressure sensor PS and an inertial measurement unit IMU, wherein data is analyzed in real time by an embedded processor to adjust massage patterns of the massage vibrators MV1-MV4. To do so, the pressure sensor PS and the inertial measurement unit IMU are configured to measure data of the human wearer, such as a posture and activity state (i.e., motion versus rest) of the human wearer. The electronic controller EC is programmed to receive this data, and to control the massage vibrators MV1-MV4 to adjust massage patterns based on the analyzed data, such as by dynamically adjusting output patterns and intensities of the massage vibrators MV1-MV4 based on the determined posture and activity state of the human wearer.

As shown in FIG. 6, the massage vest V can include a heart rate sensor HRS in the body B for detecting the human wearer's heart rate to prevent accidents or illness.

As shown in FIG. 6, the massage vest V can include a global positioning sensor GPS connected to the electronic controller EC for sending location information of the body vest B.

As shown in FIG. 6, the massage vest V a wireless communication device WCD connected to the electronic controller EC for wireless communication with mobile devices (not shown) for the main board electronic controller EC to send and receive data to control operation of the massage vest V, such as by receiving and processing the data acquired by the temperature sensor TS, the pressure sensor PS, and the inertial measurement unity IMU, the heart rate sensor HRS and/or the global positioning sensor GPS. In some examples, the wireless communication device WCD is a Bluetooth or Wi-Fi device, and the electronic controller EC is configured to receive control commands from a smartphone application (not shown) via the wireless communication device WCD and to send massage usage data to the smartphone application.

In some examples, the massage vest V includes a massage pattern memory MPM connected to the electronic controller EC for storing user-defined massage sequences and sharing or downloading massage patterns with other devices via the wireless communication device WCD. At least one signal control line SCL connects the electronic controller EC to an external control panel ECP that is located on one of the shoulder straps S1, S2, or a chest area of the vest body B. The ECP is configured to adjust massage intensity, mode, heating, or time of the massage vibrators MV1-MV4.

In some examples, the massage vest V includes a wireless charging receiving coil RC electrically connected to the rechargeable battery BT and configured to wirelessly charge the rechargeable battery BT. In some examples, the massage vest V includes at least one accessory interface AI for detachably connecting an accessory (not shown) including a sound module, a lighting module, an air purification module, or a drug release module.

With continuing reference to FIG. 6., FIG. 1 shows pre-formed pockets or mounts PFP on the vest body B in which one or more of the massage vibrators (MV4, as shown in FIG. 1) is removable mounted. Each massage vibrator MV1-MV4 is connected to a corresponding power line PL via a quick connector QC (although FIG. 1 only shows MV4 as having these features for conciseness and simplicity). Each pre-formed pocket or mount PFP includes reinforced padding at mounting positions of the massage vibrator MV1-MV4.

The present disclosure, through one or more of its various aspects, embodiments and/or specific features or sub-components, is thus intended to bring out one or more of the advantages as specifically noted below. For purposes of explanation and not limitation, example embodiments disclosing specific details are set forth in order to provide a thorough understanding of an embodiment according to the present teachings. However, other embodiments consistent with the present disclosure that depart from specific details disclosed herein remain within the scope of the appended claims. Moreover, descriptions of well-known apparatuses and methods may be omitted so as not to obscure the description of the example embodiments. Such methods and apparatuses are within the scope of the present disclosure.

1. A dynamically fitting and attachable massage vest system, comprising:
a vest body,
at least two massage vibrators,
at least two fasteners configured for releasably attaching to an associated wearable article,
at least one adjustment strap for tightening the vest body to an associated user's body,
a power compartment for housing a massage power source,
a controller embedded in the vest body, and
at least two power lines connecting the at least two massage vibrators to the controller and the controller to the massage power source.

2. The massage vest system according to claim 1, further comprising:
a temperature control layer,
a temperature sensor,
one or more heating/cooling elements; and
wherein the controller is programmed to:
analyze data measured by the temperature sensor; and
control the one or more heating/cooling elements to control a temperature of the temperature control layer based on the analyzed data.

3. The massage vest system according to claim 1, further comprising a wireless communication module for communication with mobile devices.

4. The massage vest system according to claim 3, wherein the wireless communication module is a Bluetooth or Wi-Fi module, and the controller is configured to receive control commands from a smartphone application via said wireless communication module and to send massage usage data to the application.

5. The massage vest system according to claim 3, further comprising a massage pattern memory connected to the controller for storing user-defined massage sequences and sharing or downloading massage patterns with other devices via the wireless communication module.

6. The massage vest system according to claim 1, further comprising: two or more zonal support pieces that are adjustable to achieve better fit of the vest body with the associated user's body.

7. The massage vest system according to claim 6, wherein said two or more zonal support pieces include adjustable straps.

8. The massage vest system according to claim 1, further comprising: a pressure sensor and an inertial measurement unit, and
a controller embedded in the vest body and programmed to:
analyze data measured by the pressure sensor and the inertial measurement unit; and
control the at least two massage vibrators to adjust massage patterns based on the analyzed data.

9. The massage vest system according to claim 8, wherein the controller is programmed to:
determine posture and activity state of the associated user based on data obtained by the pressure sensor and inertial measurement unit, and
dynamically adjust output patterns and intensities of the at least two massage vibrators based on the determined posture and activity state.

10. The massage vest system according to claim 1, further comprising: a heart rate sensor for detecting user's heart rate.

11. The massage vest system according to claim 1, further comprising a second fastener configured for attachment with one or more associated items.

12. The massage vest system according to claim 1, further comprising:
a first shoulder strap and a second shoulder strap attached to the vest body;
wherein the at least one adjustment strap includes:
an upper adjustment strap connecting the first shoulder strap and the second shoulder strap and including an upper adjustable fastener for drawing the first and second shoulder straps toward each other; and
a lower adjustment strap connected to a back panel of the vest body and including a lower adjustable fastener for tightening the back panel around the user's waist or hips.

13. The massage vest system according to claim 1, further comprising: at least one control signal line connecting the controller to an external control panel located on a shoulder strap or chest area of the body vest and configured to adjust massage intensity, mode, heating, or time of the at least two massage vibrators.

14. The massage vest system according to claim 1, wherein the at least two massage vibrators are removably mounted in pre-formed pockets or mounts on the vest body, and each massage vibrator is connected to a corresponding power line via a quick connector.

15. The massage vest system according to claim 1, wherein the massage power source is a rechargeable battery, and the power compartment is provided with a waterproof zipper or sealing cover.

16. The massage vest system according to claim 1, further comprising: a wireless charging receiving coil electrically connected to the power source and configured to wirelessly charge the power source.

17. The massage vest system according to claim 1, further comprising:
a back panel and shoulder straps comprising elastic and breathable material, and
reinforced padding at mounting positions of the at least two massage vibrators.

18. The massage vest system according to claim 1, further comprising: a GPS positioning sensor connected to the controller for sending location information of the body vest.

19. The massage vest system according to claim 1, wherein the vest body includes at least one accessory interface for detachably connecting an associated accessory including a sound module, a lighting module, an air purification module, or a drug release module.

20. A massage vest system, comprising:
a massage vest body having at least one shoulder strap, a back panel, at least two massage vibrators, a power source, and a controller disposed thereon;
at least one releasable fastening assembly including a strap and a buckle system, said strap adapted to wrap around the at least one shoulder strap or a fixing strap of an associated article;
wherein, when the massage vest body is attached to the associated article via said at least one fastening assembly, the back panel of the massage vest and a contact surface of said associated article together conform to a user's torso.
